(19) United States
(12) Patent Application Publication
(10) Pub. No.: US 2010/0331133 A1
(43) Pub. Date: Dec. 30, 2010

(54) SUPERPOSITION-DRIVE FOR A STEERING SYSTEM

(75) Inventors: Franz JOACHIM, Bodolz (DE); Joerg BOERNER, Friedrichshafen (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/821,687

(22) Filed: Jun. 23, 2010

(30) Foreign Application Priority Data
Jun. 30, 2009 (DE) 10 2009 027 342.5

(51) Int. Cl. F16H 37/04

(52) U.S. Cl. 475/207

(57) ABSTRACT

A superposition gear unit for a steering system of a motor vehicle. The gear unit comprising a drive input shaft (1) and a drive output shaft (2) which each carry gearwheels (3, 4; 3′, 4′) at their ends facing toward one another such that rotational movement of the input shaft (1) can be transmitted by the gearwheel (3; 3′), on the drive input side, to the gearwheel (4; 4′), on the drive output side, via external planetary gears (5a-5c; 5a′-5c′) which are mounted on a planetary gear carrier (6). The rotational movement of the input shaft (1) can be overlaid with additional rotation movement by intentional rotation of the planetary carrier (6) relative to the input shaft (1). The input-side gearwheel (3; 3′) and the output-side gearwheel (4; 4′) are, in each case, made as conical involute gearwheels.

This application claims priority from German patent application serial no. 10 2009 027 342.5 filed Jun. 30, 2009.

### FIELD OF THE INVENTION

The invention concerns a superposition gear unit for a steering system of a motor vehicle, with a drive input shaft and a drive output shaft which carry gearwheels at their ends facing toward one another, such that rotational movement of the input shaft can be transmitted from the gearwheel located on the drive input side to the gearwheel on the drive output side via external planetary gears mounted on a planetary carrier, and the rotational movement of the input shaft can be overlaid with additional rotational movement by an intentional rotation of the planetary carrier relative to the input shaft.

### BACKGROUND OF THE INVENTION

In steering systems of modern motor vehicles, in some cases so-termed superposition gear units are used, by means of which on the one hand a steering angle specified by the vehicle's driver is transmitted, appropriately geared, to a steering gear unit and on the other hand, in certain situations, the specified steering angle can be overlaid with an additional rotation. Such situations range from a controlled increase of the specified steering angle during parking maneuvers in order to produce large wheel deflections even with a small steering angle, to the controlled counteracting of undesired influences upon the driving, such as a side-wind. On the whole, difficult demands are here made on the superposition gear unit concerned as regards precision and the structural space required for it.

In this context a superposition gear unit is generally known, which comprises a drive input and a drive output shaft which carry at their ends facing toward one another a gearwheel in each case. These gearwheels are formed as crown bevel gears and are in contact with one another via external, cylindrical planetary gears. The planetary gears are mounted on a common planetary carrier, so that rotation of the drive input shaft is transmitted by the gearwheel on the drive input side to the planetary gears and by these to the gearwheel on the drive output side. Whereas during normal operation, when the planetary carrier is stationary this transmission only by rotation of the planetary gears about their respective rotational axes, the rotational movement of the input shaft can be overlaid with additional rotational movement by virtue of an intentional rotation of the planetary carrier relative to the input shaft. In this way, depending on the rotational direction of the planetary carrier, the rotational movement of the input shaft can be reinforced or delayed and, even if the drive input shaft is at rest, rotational movement of the drive output shaft can be produced.

A disadvantage of such a superposition gear unit, however, is that the production cost for making the crown gears on the drive input and drive output shafts is very high, because special production methods have to be used for this.

### SUMMARY OF THE INVENTION

Accordingly, the purpose of the present invention is to provide a superposition gear unit which entails lower production cost but at the same time is compactly designed and operates with high precision.

The invention is based on the technical principle that the gearwheels on the drive input and drive output sides are in each case made as conical involute gearwheels. This makes it possible when producing them to have recourse to the usual machining production methods for gearwheels and thereby to reduce the production cost considerably. This is because in contrast to the production of crown gears, in this case machines for the production of conventional gearwheels with involute teeth can be used. Furthermore, in the design of the superposition gear unit according to the invention the absence of, or very small play is adjusted in accordance with the axial distance between the gearwheels on the drive input and drive output sides. Thus, very precise and low-noise power transmission can be achieved.

In an embodiment of the invention the gearwheels and the planetary gears are in each case designed with helical teeth. This causes the gear unit to run more quietly since the teeth engage and disengage in a progressive manner and the degree of overlap is increased by simultaneous engagement of several teeth at a time. In addition, the bearing capacity of the individual gearwheels is improved.

In a further development of the invention the drive input and drive output shafts cross at an axis angle. This has the advantage that the superposition gear unit according to the invention can also be used in areas where structural space conditions are restricted.

A further advantageous design feature of the invention is that the planetary gears are also made as conical involute gearwheels. Thanks to this measure the planetary gears can be mounted on the planetary carrier with a small tilt angle even if the cone angle of the gearwheels on the drive input and drive output sides is very large.

In a further development of the invention at least three planetary gears are provided. This has the advantage that a compactly designed power transmission is possible so the superposition gear unit according to the invention can be a small structure.

According to an advantageous embodiment of the invention the drive input and drive output shafts cross at an axis angle of 8°, and the gearwheels on the drive input and drive output sides are each made with a cone angle in the range 8° to 12°. More advantageously still, the respective numbers of teeth on the gearwheels on the drive input and drive output sides are in each case in the range 17 to 27 teeth. This makes it possible to produce average transmission ratios in the range 5 to 15, which cannot be achieved with spur gears because of the profile displacement limits. In addition, the efficiency of a superposition gear unit of such design is high.

In an alternative embodiment of the superposition gear unit according to the invention the drive input and drive output shafts are arranged concentrically with one another and the gearwheels on the drive input and drive output sides in each case have a cone angle in the range −1° to −4°. In this case it is more advantageous for the respective numbers of teeth on the drive input side and drive output side gearwheels to be in the range 37 to 47 teeth. This makes it possible to produce an average transmission ratio of 12 to 30.

### BRIEF DESCRIPTION OF THE DRAWINGS

Below, further measures that improve the invention are explained in detail together with the description of preferred embodiments of the invention, with reference to the figures which show:

FIG. 1: Schematic representation of a first embodiment of the superposition gear unit according to the invention

FIG. 2: Perspective view of the superposition gear unit in FIG. 1, shown without shafts

FIG. 3: Schematic representation of a second embodiment of the superposition gear unit according to the invention

FIG. 4: Perspective view of the superposition gear unit in FIG. 3, shown without shafts

### DETAILED DESCRIPTION OF THE PREFERRED EMBODIMENTS

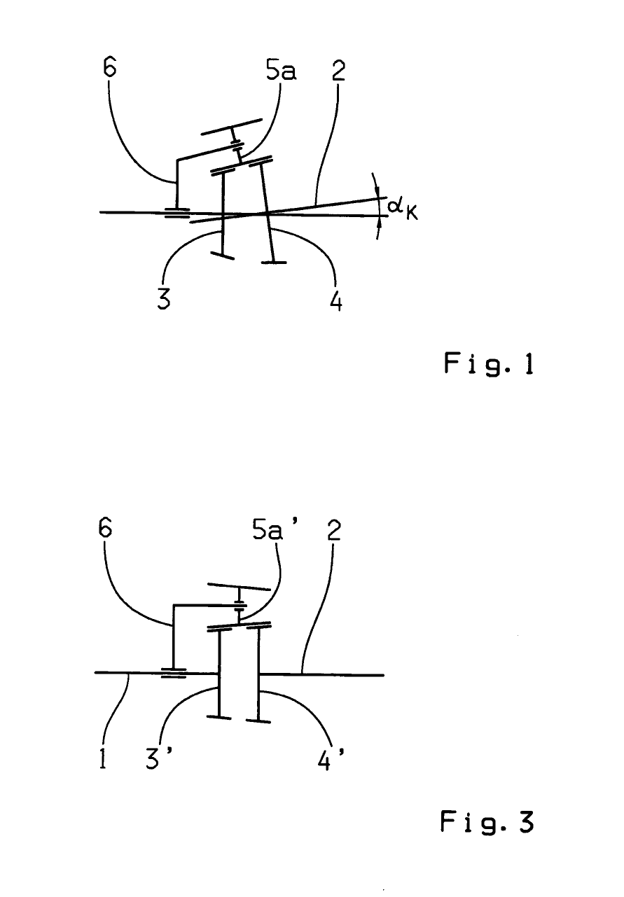

FIG. 1 shows a schematic representation of a first embodiment of the superposition gear unit according to the invention. This superposition gear unit comprises a drive input shaft 1 and a drive output shaft 2, which cross at an axis angle α_{K} and carry gearwheels 3 and 4 at their ends facing toward one another. The gearwheel 3 on the drive input side and the gearwheel 4 on the drive output side are designed as conical involute gearwheels and are in contact with one another via external planetary gears 5a-5c of which, however, only the planetary gear 5a can be seen in this representation. The planetary gears 5a-5c are in the form of cylindrical gearwheels and are mounted on a common planetary carrier 6. In this case the common planetary carrier 6 is arranged concentrically with the drive input shaft 1 and enables the planetary gears 5a-5c to rotate about their respective longitudinal central axes. As can also be seen from the perspective view shown in FIG. 2, the gearwheel 3 on the drive input side, the gearwheel 4 on the drive output side and the planetary gears 5a-5c are all made with helical teeth.

When the drive input shaft 1 rotates, the rotation movement is transmitted, appropriately geared, by the gearwheel 3 on the drive input side, via the planetary gears 5a-5c, to the gearwheel 4 on the drive output side. During normal operation this transmission takes place solely by virtue of the rotation of the planetary gears 5a-5c about their longitudinal central axes. But if the planetary carrier 6 is now rotated relative to the drive input shaft 1, then the rotational movement of the drive input shaft is overlaid by an additional rotational movement which, depending on the rotational direction of the planetary carrier 6, either reinforces or reduces the rotational movement transmitted to the drive output shaft 2. In this way, in the extreme case, when the drive input shaft 1 rotates, the drive output shaft 2 can remain stationary or, in the converse case, the drive output shaft 2 can rotate even if the drive input shaft 1 is stationary. For that reason the superposition gear unit according to the invention is particularly suitable for steering systems in motor vehicles since, for example during parking maneuvers, a steering angle specified by the vehicle's driver can be reinforced, or during normal driving operation, undesired influences on the driving, such as a side-wind, can be counteracted in a controlled manner. In the embodiment of the superposition gear unit according to the invention shown in FIGS. 1 and 2 the drive input shaft 1 and the drive output shaft 2 cross at an axis angle α_{K} of 8°, and the gearwheel 3 on the drive input side has a cone angle of 10.1° whereas the gearwheel 4 on the drive output side has a cone angle of 9.89°. In this case, with 20 teeth on the input-side gearwheel 3 and 23 teeth on the output-side gearwheel 4, if the planetary gearwheels 5a-5c each have 17 teeth average transmission ratios in the range 5 to 15 can be produced.

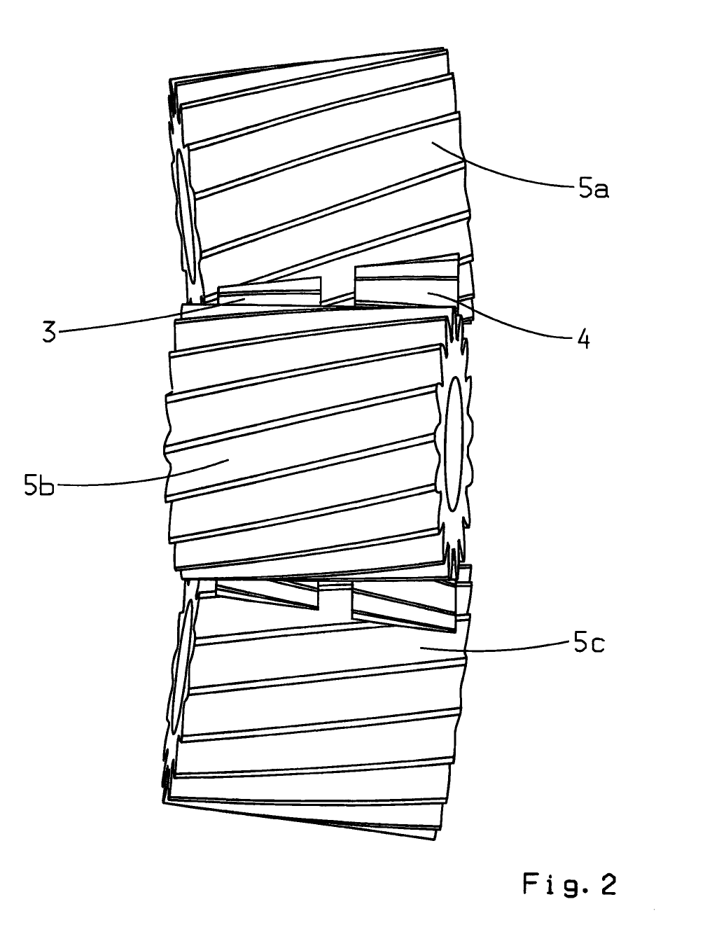

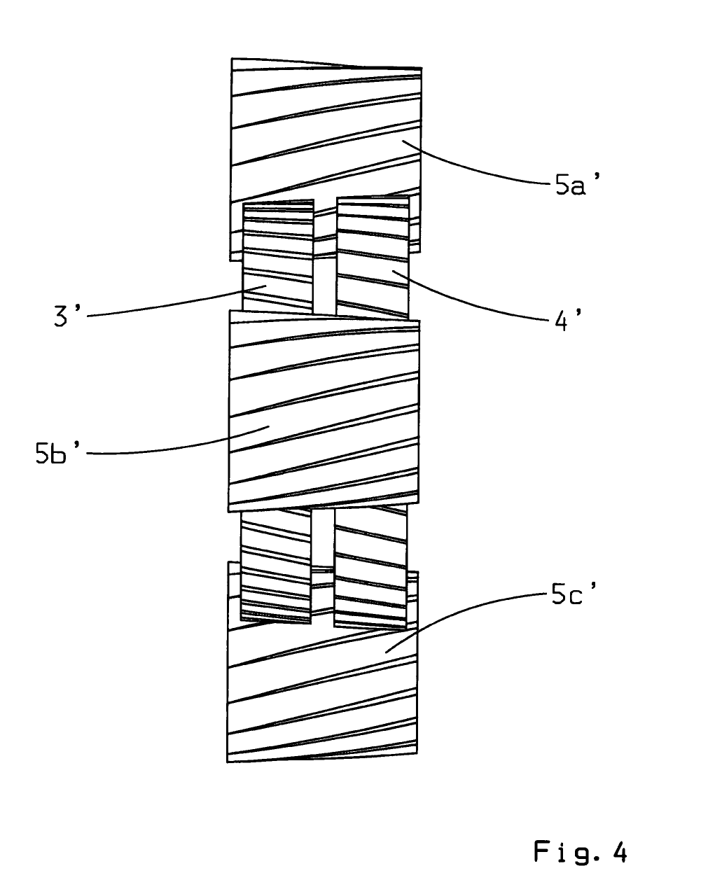

FIG. 3 shows a schematic representation of an alternative, second embodiment of the superposition gear unit according to the invention. Otherwise than in the variant described above, in this case the drive input shaft 1 and the drive output shaft 2 are arranged concentrically with one another and the input-side gearwheel 3′ is in active connection with the output side gearwheel 4′ via conical involute planetary gears 5a′-5c′. This design is particularly clearly to be seen in the perspective view shown in FIG. 4. By means of this version of the invention, when the input-side gearwheel 3′ has 40 teeth and the output-side gearwheel 4′ has 43 teeth, then if the planetary gears 5a′-5c′ each have 17 teeth, average transmission ratios in the range 12 to 30 can be obtained. The cone angles of the input-side gearwheel 3′ and the output-side gearwheel 4′ are −3° in each case while the teeth of the planetary gears 5a′-5c′ are inclined at an angle of 3°.

Thanks to the possibility of producing the conical involute gearwheels by conventional machining methods, the production cost of the superposition gear unit according to the invention is low. In addition, the absence of play, or very small play in the superposition gear unit can be adjusted by careful variation of the distance between the input-side gearwheel 3 or 3′ and the output-side gearwheel 4 or 4′.

### INDEXES

1 Drive input shaft
2 Drive output shaft
3, 3′ Gearwheel on the input side
4, 4′ Gearwheel on the output side
5a-5c, 5a′-5c′ Planetary gears
6 Planetary carrier α_{K} Axis angle

1-10. (canceled)

11. A superposition gear unit for a steering system of a motor vehicle, the superposition gear unit comprising a drive input shaft (1) and a drive output shaft (2) with gearwheels (3, 4; 3′, 4′) at respective ends thereof facing toward one another such that rotational movement of the input shaft (1) being transmittable by the gearwheel (3; 3′), on the drive input side, to the gearwheel (4; 4′), on the drive output side, via external planetary gears (5a-5c; 5a′-5c′) mounted on a planetary gear carrier (6),
rotational movement of the input shaft (1) being overlaid with additional rotational movement by intentional rotation of the planetary carrier (6) relative to the input shaft (1), and
the gearwheel (3; 3′), on the drive input side, and the gearwheel (4; 4′), on the drive output side, both being made as conical involute gearwheels.

12. The superposition gear unit according to claim 11, wherein the gearwheel (3; 3′) on the drive input side and the gearwheel (4; 4′) on the drive output side and the planetary gears (5a-5c; 5a′-5c′) all have helical teeth.

13. The superposition gear unit according to claim 11, wherein the drive input shaft (1) and the drive output shaft (2) form an angle (α_{K}) with one another.

14. The superposition gear unit according to claim 11, wherein the planetary gears (5a′-5c′) are made as conical involute gearwheels.

15. The superposition gear unit according to claim 11, wherein the planetary gear carrier (6) supports at least three planetary gears (5a-5c; 5a′-5c′).

16. The superposition gear unit according to claim 11, wherein the drive input shaft (1) and the drive output shaft (2) cross one another and form at an angle (α_{K}) with one another of 8°, and the gearwheel (3) on the drive input side and the gearwheel (4) on the drive output side are each made with a cone angle in a range of from 8° to 12°.

17. The superposition gear unit according to claim 16, wherein the gearwheel (3; 3′), on the drive input side, is an input-side gearwheel (3) and the gearwheel (4; 4′), on the drive output side, is an output-side gearwheel (4), and the input-side gearwheel (3) and the output-side gearwheel (4) each have between 17 and 27 teeth.

18. The superposition gear unit according to claim 11, wherein the drive input shaft (1) and the drive output shaft (2) are arranged concentrically with one another, the gearwheel (3; 3′), on the drive input side, is an input-side gearwheel (3) and the gearwheel (4; 4′), on the drive output side, is an output-side gearwheel (4), and the input-side gearwheel (3′) and the output-side gearwheel (4′) are each made with a cone angle in a range of from 1° to 4°.

19. The superposition gear unit according to claim 18, wherein the gearwheel (3; 3′), on the drive input side, is an input-side gearwheel (3) and the gearwheel (4; 4′), on the drive output side, is an output-side gearwheel (4), and the input-side gearwheel (3) and the output-side gearwheel (4) each have between 37 and 47 teeth.

20. A steering system for a motor vehicle comprising a superposition gear unit comprising a drive input shaft (1) and a drive output shaft (2) each carrying at least one gearwheel (3,4; 3′, 4′) at an end thereof facing toward one another such that rotational movement of the input shaft (1) being transmittable by the gearwheel (3; 3′), on the drive input side, to the gearwheel (4; 4′), on the drive output side, via external planetary gears (5a-5c; 5a′-5c′) mounted on a planetary gear carrier (6),
the rotational movement of the input shaft (1) being overlaid with additional rotational movement by intentional rotation of the planetary carrier (6) relative to the input shaft (1), and
the gearwheel (3; 3′), on the drive input side, and the gearwheel (4; 4′), on the drive output side, each being made as conical involute gearwheels.

21. A steering system of a motor vehicle which comprises a superposition gear unit, and the superposition gear unit comprising a drive input shaft (1) supporting a first gearwheel (3; 3′) and a drive output shaft (2) supporting a second gearwheel (4; 4′), the first and the second gearwheels (3, 4; 3′, 4′) being supported at an end of the respective input (1) and the output shafts (2) facing toward one another such that rotational movement of the input shaft (1) being transmittable by the first gearwheel (3; 3′) to the second gearwheel (4; 4′) via planetary gears (5a-5c; 5a′-5c′) that are supported by a planetary gear carrier (6),
the rotational movement of the input shaft (1) being combinable with rotational movement of the planetary carrier (6) relative to the input shaft (1),
each of the first and the second gearwheels (3; 3′, 4; 4′) being conical involute gearwheels, and
the input shaft (1) and the output shaft (2) being arranged at an angle of approximately 8 degrees with respect to one another.
